(19) United States
(12) Patent Application Publication
(10) Pub. No.: US 2026/0297694 A1
(43) Pub. Date: Oct. 1, 2026

(54) TUYERE FOR A METALLURGICAL FURNACE

(71) Applicant: PAUL WURTH S.A., Luxembourg (LU)

(72) Inventors: Daniel SONNTAG, Nittel (DE); Philipp KRÄMER, Trier (DE); Christian DE GRUITER, Bergem (LU)

(21) Appl. No.: 19/489,777

(22) PCT Filed: Sep. 30, 2024
(86) PCT No.: PCT/EP2024/077412

§ 371 Date: Dec. 3, 2025

(30) Foreign Application Priority Data
Oct. 24, 2023 (LU) 505347

(51) Int. Cl. C21B 7/16; C21C 5/48; F27B 1/16; F27B 3/22

(52) U.S. Cl. CPC C21B 7/163; C21C 5/48; F27B 1/16; F27B 3/22

(57) ABSTRACT

A tuyere for a metallurgical furnace includes, a conical hollow tuyere body with an inner surface and an outer surface, the tuyere extending along a first axis from an inlet end to an opposite outlet end, the tuyere body having a connection surface at the inlet end. The connection surface is configured for engaging a nose portion of a blowpipe. The tuyere further includes a sealing arrangement arranged on the connection surface, the sealing arrangement includes at least an inner seal received in an inner seal holder and an outer seal received in an outer seal holder. The seals are arranged along the first axis, wherein the outer seal is a floating seal and the inner seal is a fixed seal, and wherein the outer seal is arranged closer to the tuyere inlet end than the inner seal.

### CROSS-REFERENCE TO RELATED APPLICATIONS

This application is a 35 U.S.C. § 371 National Stage patent application of PCT/EP2024/077412, filed on 30 Sep. 2024, which claims the benefit of Luxembourg patent application 505 347, filed on 24 Oct. 2023, the disclosures of which are incorporated herein by reference in their entirety.

### TECHNICAL FIELD

The present disclosure generally relates to the field of metallurgical furnaces, and in particular to a tuyere for blowing gas into a metallurgical furnace ensuring an improved gas tightness.

### BACKGROUND

Hot gas is conventionally injected into a metallurgical furnace by means of an assembly, known as the tuyere stock, which provides a connection between the hot gas blowpipe and a tuyere, installed in the furnace wall, which opens into the furnace shaft. Typically, the tuyere stock is made up of a number of separate elements each comprising an external metal sheath and an internal refractory lining. Conventionally, the tuyere stock comprises a downpipe extending obliquely downwards from a hot air bustle pipe, an elbow and a blowpipe, having a substantially horizontal axis, attached rigidly to the elbow, the front end of the blowpipe being held in contact with the rear end of the tuyere.

Tuyeres are thus essential parts of metallurgical furnaces, such as blast furnaces, as they enable to blow gases into the furnace away from the wall and thus prevent damages to this wall. Modern blast furnaces commonly comprise more than twenty such tuyeres distributed around the circumference of the furnace wall. The tuyeres are usually inserted into a tuyere cooler comprising a circuit for a cooling fluid. Tuyere and tuyere cooler are tightly pressed into an opening of the furnace wall, called tuyere cooler holder. Because of the very harsh conditions in the furnace, the tuyere can be heavily damaged and may require replacing several times during a furnace lifetime.

The blowpipe comprises an outer wall extending towards the nose, or tip, of the blowpipe to generally form a spherically shaped wall resting swivellably against a frustoconical wall formed on the rear, inlet, end of the tuyere.

The tuyere stock is commonly supported on the external metal wall of the furnace by articulated tie rods. These tie rods provide the tuyere stock assembly with a certain freedom of movement in order to absorb the thermal deformations, both of the furnace wall and of the various elements of the tuyere stock, which inevitably arise from fluctuations in temperature.

In order to provide a seal between the various elements despite the above-mentioned deformations, it is known to use bellows compensating systems which make it possible to absorb relative motion, whether involving axial displacement or pivoting, at the connection between two elements, while still maintaining a seal, the tie rods providing a mechanical connection between the elements joined by the bellows compensators.

Such compensator systems are all the more useful for providing the tuyere stock with a certain ability to deform given that it is furthermore necessary to provide the best possible seal at the joint between the tip of the blowpipe and the tuyere, just where such systems cannot be used in particular due to the configuration in the environment of the joint, located in the thickness of the refractory wall of the furnace. This joint is thus provided simply by the tip of the blowpipe resting in centred manner against the rear end of the tuyere solely under the action of the forces arising from the weight of the tuyere stock and the tension exerted by the articulated tie rods connecting the tuyere stock to the external metal wall of the furnace. In order to permit thermal deformation which might bring about an angular offset between the blowpipe and the tuyere, the blowpipe tip commonly has a convex spherical surface in contact with a corresponding frustoconical or convex surface formed on the rear end of the tuyere.

This arrangement, forming a ball joint connection between the blowpipe and tuyere, makes it possible to ensure centring of the blowpipe on the tuyere simply by the former resting against the latter and the metal-on-metal contact between the steel of the blowpipe and the copper of the tuyere makes it possible, during relative angular displacement thereof, to maintain a substantially linear contact between them and therefore a certain level of seal between blowpipe and tuyere.

However, such a sealing is not perfect and some of the injected hot gas may leak. While it might have been possible in the past to accept some limited leaks when the injected hot gas was mainly air, it is nowadays desirable or necessary to improve the gas tightness of the joint between tuyere and blowpipe, in particular for new processes, wherein hot blast is replaced by combustible gas (H₂ or syngas). Even slight leakages could cause hazardous zones at tuyere level and should therefore be avoided.

In order to enhance the sealing performances between a tuyere and the nose of a blowpipe, CN 201 890 889 U proposed to arrange a seal between the nose of the blowpipe and the rear end of the tuyere, the seal being provided in a groove formed on the nose of the blowpipe.

More recently, WO 2013/068333 A1 proposed to mount a bellow compensator between the rear face of the tuyere and a flange made integral with the outer wall of the blowpipe. While the gas-tightness was improved, such a solution however required modifying the structure of the tuyere as well as the structure of the blowpipe and conventional blowpipes without the required flange could not be used.

### SUMMARY

The present disclosure therefore provides an improved design of a tuyere for a metallurgical furnace having an improved gas-tightness and reduced leakage without the afore-mentioned drawbacks, in particular without the need to modify the blowpipe itself.

This is solved by providing a tuyere according to the independent claim.

The disclosure overcomes the above discussed deficiencies and disadvantages by providing a tuyere for a metallurgical furnace, the tuyere comprising a conical hollow tuyere body with an inner surface and an outer surface, the tuyere extending along a first axis from an inlet end to an opposite outlet end, the tuyere body having a connection surface at the inlet end, said connection surface being configured for engaging a nose portion of a blowpipe.

The tuyere further comprises a sealing arrangement arranged on the connection surface, the sealing arrangement comprising at least an inner seal received in an inner seal holder and an outer seal received in an outer seal holder, wherein the inner and outer seals (being different form each other) are arranged along the first axis. The outer seal is a floating seal and the inner seal is a fixed seal and the outer seal is arranged closer to the tuyere inlet end than the inner seal.

The disclosure is based on the findings by the inventors that a specific sealing arrangement is desirable for ensuring a satisfying gas tightness and prevent gas leakage, and on the identification of the corresponding sealing arrangement.

One of the merits of the present disclosure is therefore to have identified that a specific sealing arrangement comprising at least two seals, the seals being different from each other and therefore having complementary features and functions, is suitable for ensuring an accurate and satisfying control of the (gas) tightness of a connection between a tuyere and a blowpipe, in particular but not limited to, for injection of hot reducing gas such as e.g. H₂ or syngas in a metallurgical furnace.

In other words, the present inventive tuyere is particularly well suited for injecting a gas comprising high amounts of hydrogen H₂ and carbon monoxide CO, i.e. a gas containing predominantly (>50 vol. %) reductant species such as CO or H₂. Proper gas tight connection between blowpipe and tuyere, and proper tuyere design are thus particularly important since the injected (i.e. blown) gas in the envisioned application contains high amounts of CO and H₂, which will spontaneously inflame when leaking to the outside or may form an explosive atmosphere when mixing with air. Conventional sealing arrangements developed for providing gas tightness toward hot blast/air (mainly comprising N₂ and O₂, i.e. molecules much bigger and less volatile than H₂) may not be tight enough to prevent hydrogen (H₂) leakage. One of the merits of the disclosure is therefore to have identified a sealing arrangement able to effectively seal a connection between a blowpipe and a tuyere against H₂ leakage and/or syngas leakage.

Due to the specific sealing arrangement, also referred to as double sealing, at least one seal is always in good contact with both surfaces (i.e. surface of the nose of the blowpipe and connection surface of the tuyere), ensuring a continuous leak-free, gas tight connection. In other words, should one of the seals temporarily loosen its connection with one of the surfaces (due to movements, thermal dilatation . . . ), the other seal ensures a continuous sealing and prevents gas leakage.

The inventors found out that the best performances were obtained when the outer seal is closer to the tuyere inlet end than the inner seal. In other words, the inner seal is closer to the outlet end of the tuyere and in use also closer to the extremity of the nose of the blowpipe than the outer seal. Due to such an arrangement of the seals, the inner seal advantageously takes most of the contact forces between the tuyere and the blowpipe, resulting in less contact forces being applied to the outer, floating seal, thereby allowing for a higher adaptability of the outer seal and a higher versatility regarding material to be used for the outer seal. Moreover, the inner seal providing for a first sealing of the tuyere to blowpipe connection, even if there is a localized or transitory imperfection in the tightness, only small quantities of hot (reducing) gas pass the inner seal and contact the outer seal. In other words, the outer seal is far less submitted to hot (reducing) gas and thus subject to less harsh conditions than the inner seal, thereby increasing the lifetime of the outer, floating seal.

Another merit of the present disclosure is for the inventors to have identified that the outer seal also provides a protecting effect of the inner seal. In case of a localized damage of the inner seal, the hot gas injected by the blowpipe may leak through such a damage. However, the outer seal prevents the gas from leaking toward the outside of the tuyere environment, thereby preventing significant heat transfer and loss of calories through the localized damage. The outer seal thus prevents a continuous energy supply to the inner seal, by means of heat due to the high temperatures of the gas leaking through the inner seal, such an energy supply being able to further damage the inner seal and leading to a complete breakage/failure thereof. That is to say, the outer seal prevents uncontrolled heat transfer toward the outside of the furnace which may result in the destruction of the inner seal.

In other words, the outer seal advantageously has a double function of further increasing the gas-tightness of the connection between a tuyere and a blowpipe by providing a double sealing, and also of protecting the inner seal against localized, undetected gas leakages which could cause the inner seal to fail completely.

The inner and outer seals may each have an (elliptical or circular) annular shape (similar to or different from one another), which may be arranged concentrically or eccentrically. In preferred embodiments, the inner and outer seal are concentric, their centers being advantageously located on the first axis.

Generally, any (floating) seal being more flexible and/or resilient than the inner seal may be used as the outer seal, such as e.g. a thin folded metallic sheet, e.g. a thin folded copper sheet or a thin folded steel sheet, however in preferred embodiments, the two seals are made from different materials, i.e. the material of the inner seal is different from the material of the outer seal. More preferably, the outer (second) seal is made of a material softer than the material of the inner (first) seal, the second (outer) seal being preferably made of a material such as but without being limited to, rubber, more preferably made of nitrile butadiene rubber (NBR), hydrogenated nitrile butadiene rubber (HNBR), silicone, fluoroelastomers, such as Fluorine Kautschuk Material (FKM) or Viton®, polytetrafluoroethylene (PTFE), etc. It is advantageously possible to use a soft material such as e.g. a rubber for the outer seal as the outer seal is arranged further away from the tuyere outlet end than the inner seal and thus contacts less hot gas than the inner seal, which provided a first sealing effect. Moreover, a softer outer seal (with respect to the inner seal) further increase the tightness of the connection between tuyere and blowpipe.

The inner (i.e. first) seal may present a hardness of about 30 HV (Vickers hardness) to about 300 HV when measured under a load of 5 kgf or 10 kgf, preferably between about 35 HV and about 290 HV, and the outer (i.e. second) seal may present a hardness of about 60 to less than 100, preferably 70 to 95 or 75 to 90, according to the Shore A scale.

Another merit of the present disclosure is that outer seal is a floating seal, i.e. the outer seal is floating in its respective outer seal holder, which advantageously allows to compensate shape deviations due to movement, thermal dilatation and tolerances without the need for a dedicated compensator, such as e.g. a bellow compensator. As the outer seal is floating, it can always be in contact with the nose of the blowpipe by self-aligning in its seal holder, thereby ensuring a better and permanent contact and an improved tightness. In other words, due to the floating nature of the outer seal, gas tightness is ensured even when the respective rotation centers (of the tuyere and the blowpipe) are not perfectly aligned. If the tuyere moves e.g. by thermal expansion of the whole gas feeding system, the inner, fixed, seal may leak, due to some misalignments. However, the outer floating seal will advantageously always stay in contact with the nose portion of the blowpipe no matter how deformed the nose of the blowpipe becomes, thereby ensuring a gas-tight, leak-free connection between tuyere and blowpipe.

That is to say, the specific sealing arrangement comprising the floating outer seal and the fixed inner seal eliminates the need for a compensator, thus facilitating and speeding up the assembling process as well as the disassembling process between tuyere and blowpipe. It is easier and faster to dismount the tuyere for maintenance or replacement operation, thereby advantageously reducing the time needed for maintenance operation of the metallurgical furnace.

Preferably, the specific shape of the outer seal together with a smooth (internal) surface (of the blowpipe) and use of e.g. a tight rubber allows the outer seal to float by sliding on the sealing surface (of the blowpipe).

Yet another merit of the present disclosure is that the inventive tuyere advantageously fits in conventional setups, so that existing installations may easily be retrofitted to improve (i.e. increase) their gas tightness during normal maintenance operation, merely by replacing damaged tuyeres with tuyeres according to the disclosure and without needing to replace or retrofit other pieces of equipment such as e.g. the blowpipe.

Preferably, the outer seal is an active floating seal controlled by gas, i.e. due to the inner pressure in the outer seal holder, the outer seal is advantageously moved, i.e. pushed, toward the nose portion of a blowpipe, until the inner pressure in the outer seal holder reaches the pressure outside the seal holder. In other words, such a gas-controlled floating seal will be floating in its respective holder until the inner pressure creates a force equivalent to the contact force of the seal on the blowpipe. The contact force will automatically be equal to the inner pressure. In embodiments, the outer seal may be a floating translational seal, i.e. may be moved by a translational movement toward or from the nose portion of the blowpipe.

Advantageously, if a gas leakage is about to occur at the inner seal, the leaking gas will increase the inner pressure on the outer seal holder and push the outer seal toward the nose portion of the blowpipe, thereby actually reinforcing the tightness of the connection and actively counteracting any leakage. In other words, if gas leakage is about to occur, it will result in a positive counteraction that will further improve the sealing performances of the outer seal and thereby efficiently prevent leakage.

In embodiments, it may be preferred that the sealing arrangement further comprises an inert gas supply pipe arranged and configured for injecting an inert gas, such as e.g. argon or nitrogen, in the outer seal holder, in order to generate an overpressure within the outer seal holder, which in turn will push the outer seal (by a translational movement) toward the nose portion of the blowpipe, thereby improving the sealing and reducing leakage. In other words, gas tightness will be actively increased by generating an overpressure, preferably of at least 0.2 bar g, more preferably at least 0.3 bar g, even more preferably at least 1 bar g, with respect to the pressure in the metallurgical furnace, thereby efficiently preventing gas leakage. Moreover, should the sealing arrangement nonetheless be about to fail, leaking hot gas will be pushed (i.e. directed) back toward the inside of the furnace by the injected inert gas due to the overpressure of the inert gas in the outer seal holder. In other words, the overpressure of the inert gas in the outer seal holder advantageously provides a further security against hot gas leakage outside the furnace interior as the inert gas tends to push back any potentially leaking gas.

Further advantageously, the inert gas may act as an indicator of hot gas leakage, i.e. may indicate the presence of damages to the sealing arrangement, as the inert gas consumption will increase should hot gas leak through the sealing arrangement. Damages to the sealing arrangement may thus be detected at an early stage and maintenance operation may be planned well before complete or even before any significant failure of the sealing arrangement.

Yet further advantageously, the injected inert gas provides a cooling effect in the vicinity of the outer seal, allowing for a thermal protection of the outer seal and hence a wider choice of materials for the outer seal. In other words, the outer seal with such an active inert gas sealing and protecting system may be referred to as a cooled seal, as it would advantageously also be cooled by the injected inert gas.

The tuyere can be of any kind, in particular the tuyere may comprise a single chamber, a double chamber and/or a spiral chamber. In embodiments, the tuyere may be water cooled, advantageously ensuring that the temperature of the sealing arrangement does not exceed 300° C., preferably does not exceed 200° C., thereby increasing the lifetime of the (preferably rubber) outer seal.

Advantageously, the tuyere can be made of any metallic material or an alloy of any metallic materials to ensure its resistance to heat and abrasion. However, the tuyere is preferably made of copper, copper alloy, steel or steel alloy or combinations thereof.

In embodiments, the inner seal is a metallic seal such as e.g. a seal made of copper or steel, or the inner seal is a graphite seal. In preferred embodiments, the inner seal is a hard, metallic primary seal to take forces and high temperatures and the outer seal is a soft, floating and gas energized secondary seal to properly seal the connection between tuyere and blowpipe.

According to the same or alternative embodiments, the inner seal has a shape configured for ensuring a cone to sphere contact with the nose portion of a blowpipe (i.e. the inner seal is shaped to ensure a cone to sphere contact with the nose portion of the blowpipe).

In embodiments, at least one seal is made in one piece, preferably each seal is made in one piece. A seal being made in one piece means that the seal is made integral/continuous/undivided into radial subportions.

In embodiments, the inner seal has dimensions substantially corresponding to inner dimensions of the inner seal holder (i.e. the inner seal may not move in its respective inner seal holder). Additionally or alternatively, a height of the inner seal holder along a direction substantially perpendicular to the first axis is greater than a height of the outer seal holder, preferably the height of the inner seal holder is from 1.1 to 2 times the height of the outer seal holder, such as at least 1.2 times the height of the outer seal holder, more preferably the height of the inner seal holder is at least 1.5 times the height of the outer seal holder.

In embodiments, the tuyere may further comprise a scraper arranged on the connection surface, the scraper being preferably arranged further away from the inlet end than the sealing arrangement (i.e. rearwardly with respect to the sealing arrangement). Scrapers are conventional in the field of tuyere parts for metallurgical furnace and the skilled person knows how to design and dimension a scraper in order to scrape and clean the nose portion of a blowpipe (in particular where the sealing arrangement will seat in use) received in the tuyere.

According to another aspect, the present disclosure relates to a gas feeding system for a metallurgical furnace comprising at least one tuyere as described above and at least one blowpipe, wherein a nose portion of the blowpipe is pressed against the connection surface of the tuyere.

In embodiments, the nose portion of the blowpipe is cooled, preferably water-cooled. Such a cooled nose portion advantageously enables to lower the temperature in the vicinity of the tuyere-blowpipe connection, and thus lower the temperature of the sealing arrangement, thereby increasing the lifetime of the outer seal. Additionally or alternatively, the nose portion may be exchangeable, i.e. only the nose portion may be changed when damaged, without having to replace the whole blowpipe.

According to yet another aspect, the present disclosure also concerns a metallurgical furnace, such as a blast furnace, comprising at least one tuyere as described herein or a gas feeding system as described herein.

The gas feeding system according to the disclosure and the metallurgical furnace according to the disclosure retain all the advantages of the tuyere according to the disclosure.

In the present context, it seems clear that any kind of gas may be injected by the blowpipe through the inventive tuyere when in use, such as e.g. hot blast, syngas or hydrogen (H₂). The expression “blast furnace” when used in the present text can therefore refer to any metallurgical furnace operated with air/oxygen containing blast in the context of conventional(ly operated) shaft reduction and melting (smelting) furnaces or to shaft reduction and melting furnaces operated according to a method wherein the blast is essentially replaced with a reducing gas, such as e.g. syngas or hydrogen.

### BRIEF DESCRIPTION OF THE DRAWINGS

Further details and advantages of the present disclosure will be apparent from the following detailed description of not limiting embodiments with reference to the attached drawing, wherein:

FIG. 1 is a schematic view of a general arrangement of a tuyere stock;

FIG. 2 is a schematic sectional view along the first axis of a tuyere according to a first embodiment of the disclosure;

FIG. 3 is an enlarged schematic view of the sealing arrangement of the tuyere of FIG. 2;

FIG. 4 is an enlarged schematic view of a sealing arrangement of a tuyere according to a second embodiment of the disclosure;

FIG. 5 is an enlarged schematic view of a sealing arrangement of a tuyere according to a third embodiment of the disclosure; and

FIG. 6 is an enlarged schematic view of a sealing arrangement of a tuyere according to a fourth embodiment of the disclosure.

### DETAILED DESCRIPTION OF THE DRAWINGS EMBODIMENTS

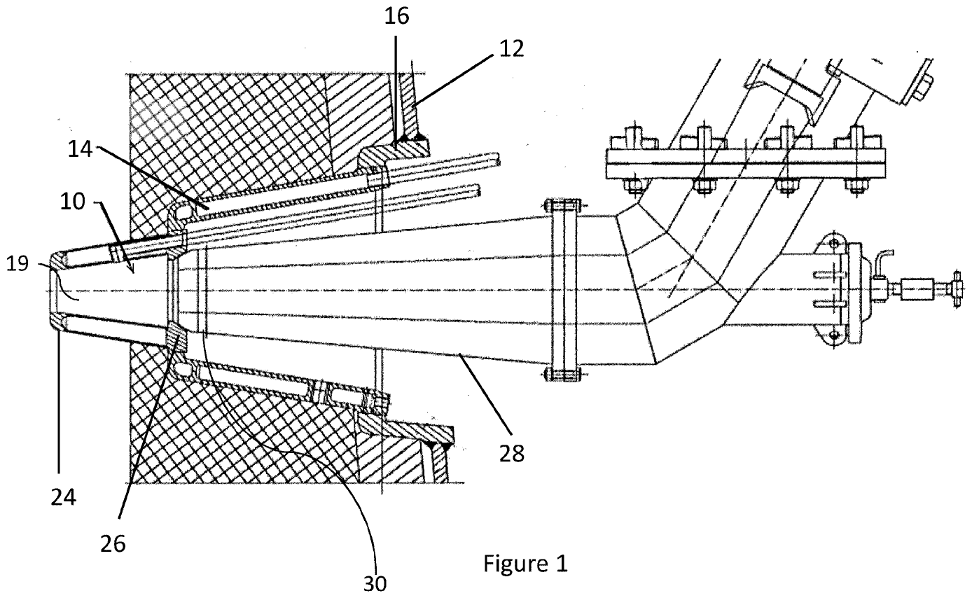

In a metallurgical furnace, a number of tuyeres 10 are generally located inside the furnace wall 12 in order to feed hot gas into the furnace. As displayed on FIG. 1, a tuyere 10 is arranged in a furnace wall 12, usually within a tuyere cooler 14, which is, in turn arranged in a tuyere holder 16. The tuyere 10, tuyere cooler 14 and tuyere holder 16 are securely wedged into each other by means of conical surfaces narrowing in the direction of the interior of the furnace.

The tuyere 10 has a conical hollow tuyere body 18 with an inner surface 20 and an outer surface 22. The tuyere body 18 defines an inner passageway 19 and extends along a first axis A-A from an outlet end 24 opening into the interior of the furnace to an inlet end 26 receiving the nose portion 30, or tip, of a blowpipe 28.

The blowpipe 28 comprises a tubular body 32 extending along an axis, which in use substantially corresponds to the axis A-A of the tuyere body 18, from a respective inlet end toward a nose portion 30. An outer wall 34 of the nose portion 30 is formed with a substantially spherical shape resting swivellably against a connection surface 36 provided at the inlet end of the tuyere. The connection surface 36 has a frustoconical shape.

As the nose portion 30 of the blowpipe 28 presents a substantially spherical shape and the connection surface 36 of the tuyere 10 presents a substantially frustoconical shape, the contact between the tuyere 10 and the blowpipe 28 may generally be referred to as a cone to sphere contact, and the contact line between the nose portion 30 of the blowpipe and the connection surface 36 of the tuyere may be substantially annular. The contact line may however not form an exact circle, but may rather present an ellipsoidal shape, i.e. an elliptical or circular annular shape, due to relative movements of the blowpipe 28 and the tuyere 10 when in use.

A sealing arrangement 38 is provided on the connection surface 36, in order to ensure a gas-tight contact between the nose portion 30 of the blowpipe 28 and the tuyere 10, and prevent any gas leakage.

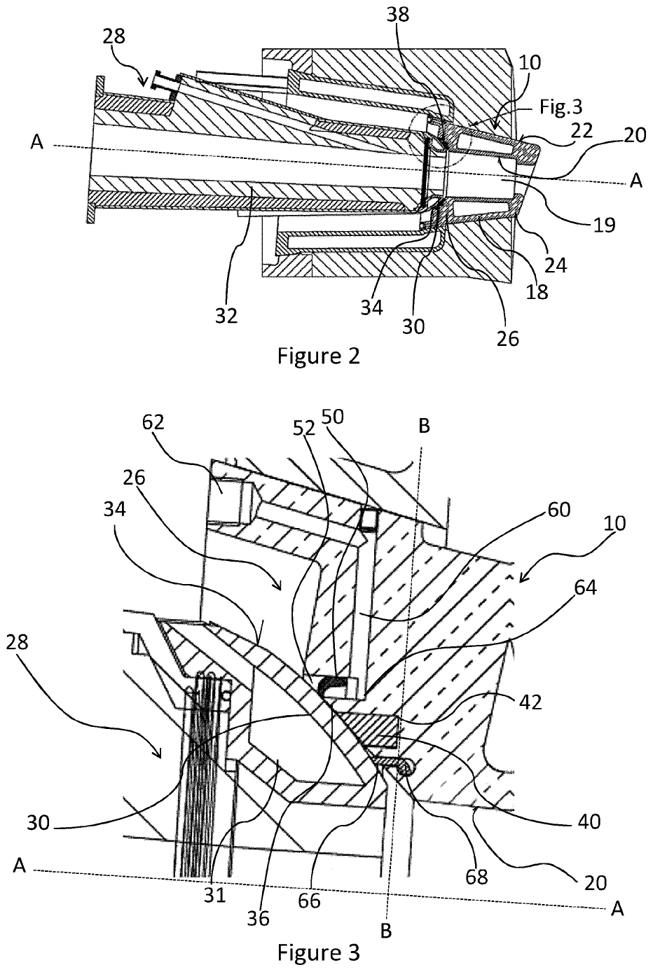

As apparent from FIG. 2 and FIG. 3, the sealing arrangement 38 comprises a inner seal 40 arranged in a respective inner seal holder 42. The shape and dimensions of the inner seal holder 42 substantially correspond to the shape and dimensions of the inner seal 40, i.e. the inner seal 40 and the inner seal holder 42 are assembled by a form-fit, non-floating connection.

The inner seal 40 is an annular seal and is formed integral, i.e. it extends as one piece, undivided into radial sub-portions, around the inner passageway 19.

As apparent from FIG. 3, the contact line between the nose portion 30 of the blowpipe 28 and the tuyere 10 mainly occurs in the region of the inner seal 40. The inner seal 40 is thus shaped so as to ensure a cone to sphere contact with the nose portion 30 of the blowpipe.

In embodiments, a cross-section of the inner seal 40 presents a truncated rectangular shape, with an oblique portion forming an angle with the first axis A-A substantially corresponding to an inclination angle of the outer wall 34 of the nose portion 30 of the blowpipe 28 with respect to the first axis A-A.

The inner seal 40 may be a metal seal or a graphite seal.

The sealing arrangement 38 further comprises a outer seal 50 arranged in a outer seal holder 52. The outer seal 50 is generally arranged further away from the tuyere outlet end 24, i.e. closer to the inlet end 26, than the inner seal 40.

As the contact line is mainly formed in the region of the inner seal 40, the inner seal 40 takes up most of the resulting contact forces so that the outer seal 50 may be made of a softer and/or more resilient material than the inner seal 40. In embodiments, the outer seal 50 comprises or is made of rubber or fluoroelastomers, such as e.g. commercial Fluorine Kautschuk Material (FKM) known under the name Viton® and/or (hydrogenated) nitrile butadiene rubber. Other appropriate materials may include silicone (rubber) and/or PTFE.

As for the inner seal 40, the outer seal 50 is an (roughly) annular seal and is formed integrally, i.e. it extends as one piece, undivided into radial sub-portions, around the inner passageway 19.

According to the present disclosure, the outer seal 50 is a floating seal, i.e. the outer seal 50 is arranged to float in its respective outer seal holder 52. In other words, the outer seal holder 52 is designed and dimensioned so that the outer seal 50 may move, i.e. float, therein in order to accommodate deformation of the connection (contact line, seat) between the tuyere 10 and the nose portion 30 of the blowpipe 28, due to relative movements thereof when in use and/or to increase the sealing pressure of the seal on its seat.

As apparent from FIG. 3 to FIG. 6, the outer seal holder 52 is smaller than the inner seal holder 42. Preferably, a height of the inner seal holder 42 in a direction along a second axis B-B substantially perpendicular to the first axis A-A is greater than a height of the outer seal holder 52. In embodiments, the height of the inner seal holder may be 1.1 to 2 times the height of the outer seal holder, such as e.g. about 1.2, 1.3, 1.4 or 1.5 times higher.

The outer seal 50 may have an arcuate shaped cross-section, arranged so that the convex portion faces the inner passageway 19 of the tuyere body 18.

As apparent from FIG. 4 to FIG. 6, it is still within the scope of the present disclosure that the outer seal may present any other shape adapted for ensuring a gas-tight and leak-free connection between the nose portion of the blowpipe and the tuyere.

The outer seal 150 may have a U-shaped cross-section, the U-shape being arranged substantially horizontally within the outer seal holder so that the branches 150.1, 150.2 of the U-shape point toward the tuyere body and the central portion 150.3 is arranged proximal to the inner passageway 19 of the tuyere (FIG. 4).

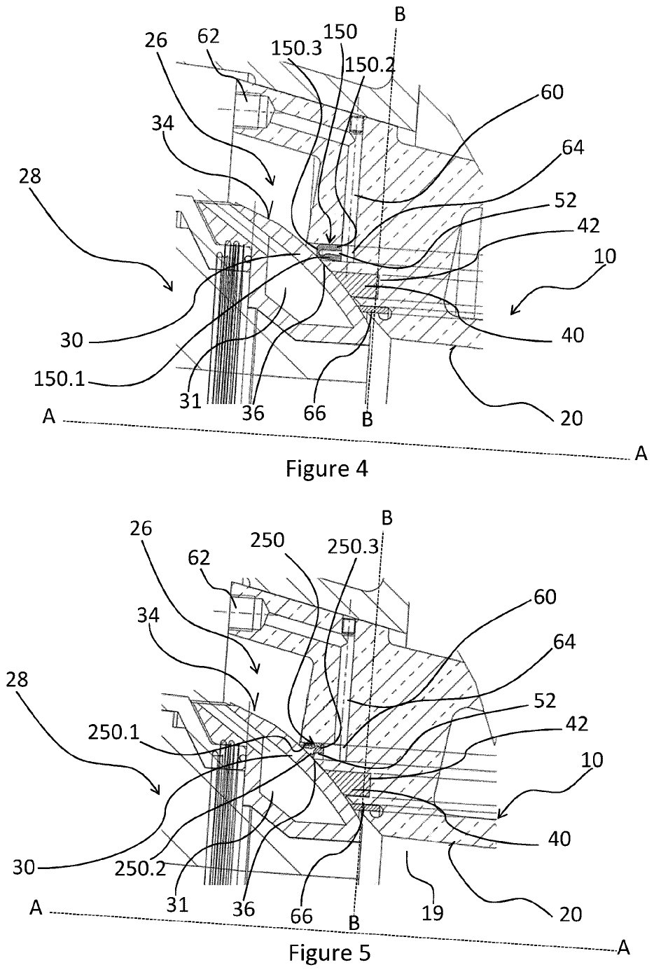

Alternatively, the outer seal 250 may comprise a base portion 250.3 having a substantially rectangular shape and two legs 250.1, 250.2 extending from the base portion 250.3 toward the inner passageway 19 of the tuyere (FIG. 5). The two legs 250.1, 250.2 may be sequentially arranged along a height, along the second axis B-B, of the base portion, so that in use the upper leg 250.1 extends substantially along the first axis A-A and the second leg 250.2 extends substantially along the second axis B-B, a contact force resulting from the nose portion 30 of the blowpipe 28 being pressed against the connection surface of the tuyere spreading apart the two legs 250.1, 250.2.

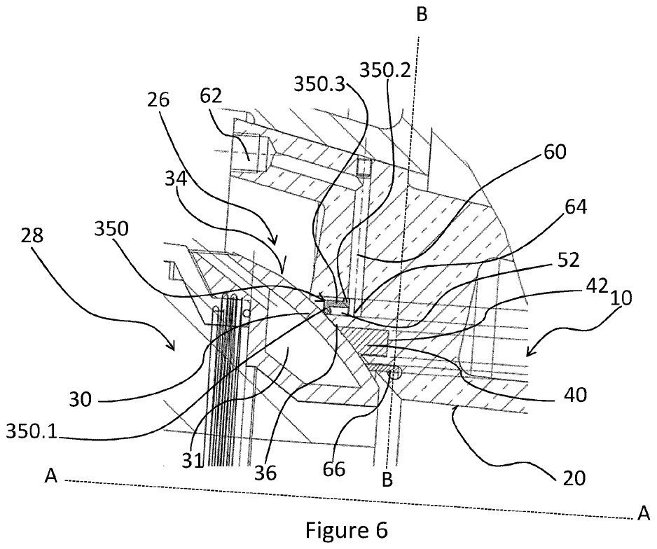

Further alternatively, the cross-section of the outer seal 350 may present a main potion 350.3 having a generally rectangular cross-section, with its main extension substantially along the direction of the A-A axis, and two legs 350.1, 350.2 extending from the main portion 350.3 substantially along the direction of the B-B axis, one of the legs 350.1 being arranged at one end of the main portion 350.3 (e.g. proximal to the inner passageway 19 of the tuyere 10) and extending in a direction toward the inner surface 20 of the tuyere body and the other leg 350.2 being arranged at the other end of the main portion 350.3 (e.g. distal form the inner passageway 19 of the tuyere 10) and extending in a direction away from the inner surface 20 of the tuyere 10 (FIG. 6). In embodiments, a guiding ring may be provided on the surface of the outer seal holder for guiding one of the legs, such as e.g. leg 350.2, thereby advantageously lowering friction forces to the outer, floating seal.

The sealing arrangement 38 may further comprise an inert gas supply pipe 60 arranged and configured for injecting an inert gas in the outer seal holder 52. The inert gas supply pipe 60 extends from a respective inlet 62 toward a respective outlet 64 opening in the outer seal holder 52 behind the outer seal 50. As apparent from FIG. 3 to FIG. 6, behind the outer seal 50, 150, 250, 350 means that the outer seal 50, 150, 250, 350 is arranged between the inner passageway 19 of the tuyere and the outlet 64 of the inert gas supply pipe 60.

In use, an inert gas such as e.g. nitrogen, may be supplied to the outer seal holder 52 with a flow rate sufficient to ensure an overpressure in the outer seal holder 52 of at least 0.2 bar or at least 0.3 bar or even at least 1 bar with respect to the pressure inside the metallurgical furnace. Such an overpressure due to the supplied inert gas exerts a force on the outer seal 50, forcing the seal 50 against the outer wall 34 of the nose portion 30 of the blowpipe 28, thereby improving the gas-tightness of the connection between the tuyere 10 and the nose portion 30.

Moreover, the supplied inert gas has a cooling effect on the outer seal 50, i.e. the outer seal 50 is cooled (by the inert gas injected in the outer seal holder 52).

A scraper 66 may advantageously be provided on the connection surface 36 of the tuyere 10, rearwardly with respect to the sealing arrangement 38, i.e. further away from the inlet end 26 than the sealing arrangement 38. Scrapers are conventional in the field of tuyere parts for metallurgical furnace and the skilled person knows how to design and dimension a scraper in order to scrape and clean the nose portion of a blowpipe (in particular where the sealing arrangement will seat in use) received in the tuyere. In embodiments, the scraper 66 may be formed as an annular scraper with a substantially parallelepipedal cross-section, but other shapes are however possible (e.g. with—as on FIGS. 2 and 3—or without—as on FIG. 4 to 6—a retaining extension 68 arranged at a second end opposite a first end configured for scrapping material).

As apparent from FIG. 2 to FIG. 6, the blowpipe 28 may have an exchangeable (i.e. replaceable) nose portion 30 incorporating a cast-in tube 31 which may be supplied with coolant in order to cool the nose portion 30.

While the disclosure has been illustrated and described in detail in the drawings and foregoing description, such illustration and description are to be considered illustrative or exemplary and not restrictive; the disclosure is not limited to the disclosed embodiments.

1. A tuyere for a metallurgical furnace, the tuyere comprising: a conical hollow tuyere body with an inner surface and an outer surface, the tuyere extending along a first axis from an inlet end to an opposite outlet end, the tuyere body having a connection surface at the inlet end, said connection surface being configured for engaging a nose portion of a blowpipe,
the tuyere further comprising a sealing arrangement arranged on the connection surface, the sealing arrangement comprising at least an inner seal received in an inner seal holder and an outer seal received in an outer seal holder, the seals being arranged along the first axis, wherein the outer seal is a floating seal and the inner seal is a fixed seal, and wherein the outer seal is arranged closer to the tuyere inlet end than the inner seal, and
wherein the outer seal is always in contact with the nose portion of the blowpipe by self-aligning in the outer seal holder.

2. The tuyere as claimed in claim 1, wherein the inner and outer seals are made from different materials, and wherein the outer seal in is made of a material softer than the material of the inner seal.

3. The tuyere as claimed in claim 1, wherein the outer seal is a floating translational seal.

4. The tuyere as claimed in claim 1, wherein at least one seal has a substantially annular shape.

5. The tuyere as claimed in claim 1, wherein at least one seal is made in one piece.

6. The tuyere as claimed in claim 5, wherein the outer seal comprises or is made of rubber, preferably nitrile butadiene rubber, hydrogenated nitrile butadiene rubber, silicone, fluoroelastomers, such as Fluorine Kautschuk Material, polytetrafluoroethylene, more preferably nitrile butadiene rubber, hydrogenated nitrile butadiene rubber or Fluorine Kautschuk Material.

7. The tuyere as claimed in claim 1, wherein a height of the inner seal holder along a direction substantially perpendicular to the first axis is greater than a height of the outer seal holder.

8. The tuyere as claimed in claim 1, wherein the sealing arrangement further comprises an inert gas supply pipe arranged and configured for injecting an inert gas in the outer seal holder.

9. The tuyere as claimed in claim 1, wherein the inert gas supply pipe is configured for generating an overpressure of at least 0.2 bar g, with respect to the pressure in the metallurgical furnace.

10. The tuyere as claimed in claim 1, wherein the inner seal has a shape configured for ensuring a cone to sphere contact with the nose portion of a blowpipe.

11. The tuyere as claimed in claim 1, wherein the inner seal has dimensions substantially corresponding to inner dimensions of the inner seal holder.

12. The tuyere as claimed in claim 1, wherein the inner seal is a metallic seal, or wherein the inner seal is made of graphite.

13. The tuyere as claimed in claim 1, further comprising a scraper arranged on the connection surface.

14. A gas feeding system for a metallurgical furnace comprising at least one tuyere as claimed in claim 1 and at least one blowpipe, wherein a nose portion of the blowpipe is pressed against the connection surface of the tuyere.

15. The gas feeding system as claimed in claim 14, wherein the nose portion of the blowpipe is cooled.

16. A metallurgical furnace, such as a blast furnace, comprising at least one tuyere as claimed in claim 1 or a gas feeding system 15 for a metallurgical furnace comprising the at least one tuyere and at least one blowpipe, wherein a nose portion of the blowpipe is pressed against the connection surface of the tuyere.
